(19) United States
(12) Patent Application Publication
(10) Pub. No.: US 2007/0034656 A1
(43) Pub. Date: Feb. 15, 2007

(54) Foldable clothesline apparatus

(76) Inventors: John Davis, Plainfield, CT (US); Joanne Davis, Plainfield, CT (US)

Correspondence Address: SOFER & HAROUN LLP., 317 MADISON AVENUE, SUITE 910, NEW YORK, NY, 10017, US

(21) Appl. No.: 11/449,338

(22) Filed: Jul. 5, 2006

Related U.S. Application Data
(60) Provisional application No. 60/700,401, filed on Jul. 19, 2005.

(51) Int. Cl. B60R 11/00

(52) U.S. Cl. 224/497

(57) ABSTRACT

An expandable and foldable clothesline apparatus adapted to attach to a vehicle hitch via a trailer coupler. The trailer coupler connects to a ball unit and a ball mount. The ball mount is attached to a horizontal member having a first end and a second end. Two pivoting arms attach to the horizontal member at the first and second ends via pivot joints. Each pivoting arm has a free end and is rotated about its respective pivot joint to an extended and open position, allowing a number of lines to be secured between the pivoting arms for hanging clothing. An expandable and collapsible clothesline apparatus adapted to attach to a vehicle hitch via a trailer coupler. The trailer coupler connects to a ball unit and a ball mounting plate. The ball mounting plate is attached to a horizontal member having a first end and a second end. Two pivoting arms attach to the horizontal member at the first and second ends via pivot joints. Each pivoting arm has a free end and is rotated about its respective pivot joint to an extended and open position, allowing a number of lines to be secured between the pivoting arms for hanging clothing.

### FIELD OF THE INVENTION

This invention relates generally to a clothesline device for vehicles, and more particularly, to a foldable clothesline apparatus for use with a trailer coupler.

### BACKGROUND OF THE INVENTION

People utilizing trailers on vacations, camping trips, or other activities often need to dry their clothing after swimming or doing laundry. If the trailers are not equipped with dryers, then people often have to resort to draping their clothes over a chair or a portion of their vehicle, which does not allow for efficient drying and can sometimes even dirty the clothing or wear down the surface coating of the vehicle. In addition, sometimes exterior chairs or other seats are not available.

A number of clothesline devices are revealed in the prior art that are potentially adaptable for use in camper vehicles.

U.S. Pat. No. 4,192,426 discloses a clothesline device installed between the walls at opposite ends of an indoor bath or between an outdoor balcony railing and a building wall.

U.S. Pat. No. 4,592,472 discloses a chain supported at its opposite ends by bracket members, which are themselves supported by mounting strips attached to walls.

U.S. Pat. No. 4,856,661 discloses collapsible clothes hangers that attach to the back of a vehicle by a mount. This device contains several hangers that function as separate arms which rotate and fan away from a support block. The arms of the device can be used to hold clothing directly. The device does not utilize a clothesline, and its arms attach to the support block's center, not at its ends.

U.S. Pat. No. 5,090,578 discloses a clothesline device that clamps onto a windowsill. The device contains individual clothesline units in a parallel arrangement extending out from the windowsill.

U.S. Pat. No. 5,582,304 discloses a clothesline device attached to a trailer via separate mounting plates. Separate arms attach to the mounting plates and the clotheslines are hung between the arms. This device does not fold or have rotating joints and thus is not collapsible.

Thus, while the foregoing body of art reveals a number of clothesline devices that potentially attach to an interior or exterior portion of a vehicle, such devices are limited in size by the width of the opposing walls, the bed platform, or the windows to which they attach. In addition, these devices do not possess a ball unit and a ball mounting plate having a foldable clothesline that attaches to a trailer coupler.

### BRIEF SUMMARY OF THE INVENTION

An object of the present invention is to provide a collapsible clothesline apparatus that is attachable to a trailer coupler, and contains hanging space that is not limited by the width or other dimensions of the trailer. Another object of the present invention is to provide for easy assembly, setup, removal, and space savings with regard to the use of the collapsible clothesline apparatus.

These and other objects are achieved by attaching the clothesline apparatus to a trailer coupler via a ball unit and a ball mounting plate. The clothesline apparatus includes a horizontal member with first and second ends, two pivotally connected arms that attach to the horizontal member at the first and second ends via pivot joints, and a ball unit attached to a ball mounting plate, which connects the trailer coupler to the clothesline apparatus.

Each pivot joint contains two small parallel metal plates welded and/or bolted to the exterior surface of the horizontal member and a pivot bolt that passes perpendicularly through the metal plates and the pivot arm. Each pivoting arm has a free end and ¼″ holes drilled at various distances from its free end. The pivoting arms are rotated about their respective pivot joints to an extended and open position, allowing a number of lines for hanging clothing to be secured at the ¼″ hole locations between the pivoting arms.

The space between the free ends of the two arms can be adjusted by rotating the arms about their respective joints and then tightening the joints via nylock nuts and a locking pin, or by some other equivalent securing mechanism.

### BRIEF DESCRIPTION OF THE DRAWINGS

FIG. 1 is a representation of the front perspective view of the collapsible clothesline apparatus, in the open position, embodying various features of the present invention;

FIG. 2 is the collapsible clothesline apparatus of FIG. 1 in the closed position;

FIG. 3 is a top perspective view of the ball unit and the ball mounting plate of the collapsible clothesline apparatus of FIG. 1;

FIG. 4 is a bottom perspective view of the ball unit and the ball mounting plate of the collapsible clothesline apparatus of FIG. 1; and

FIG. 5 is a front perspective view of the pivot joint of the collapsible clothesline apparatus of FIG. 1.

### DETAILED DESCRIPTION OF THE INVENTION

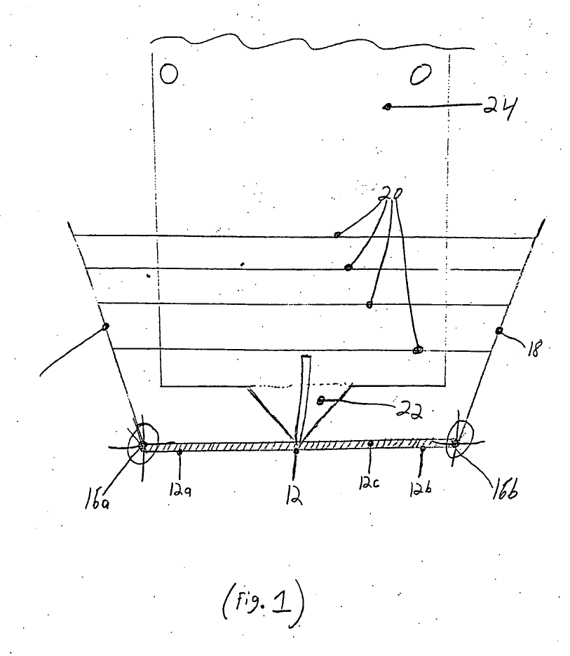

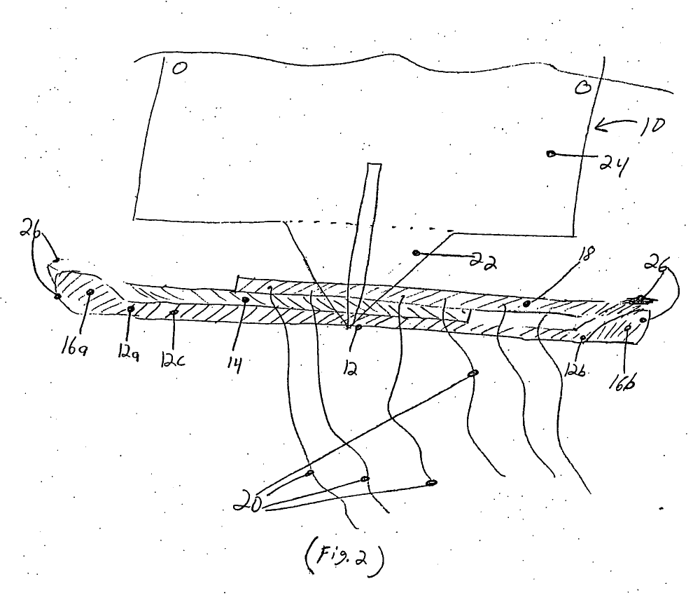

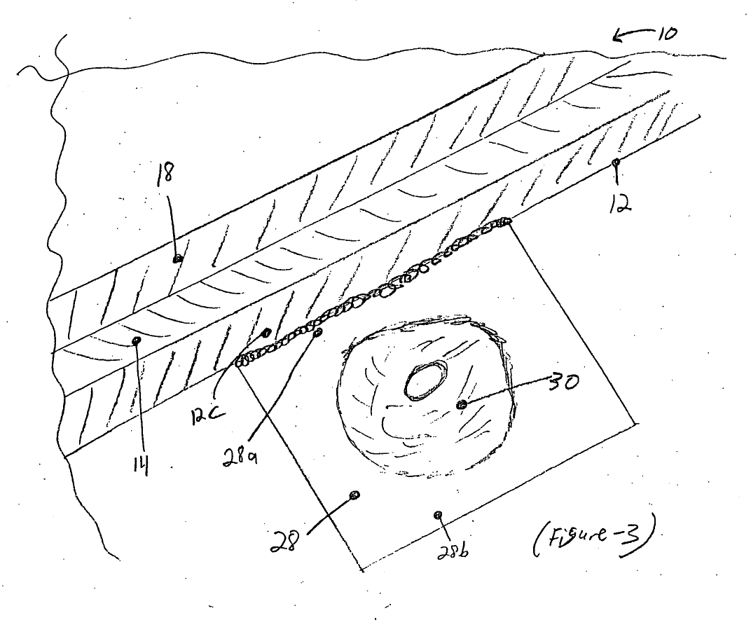

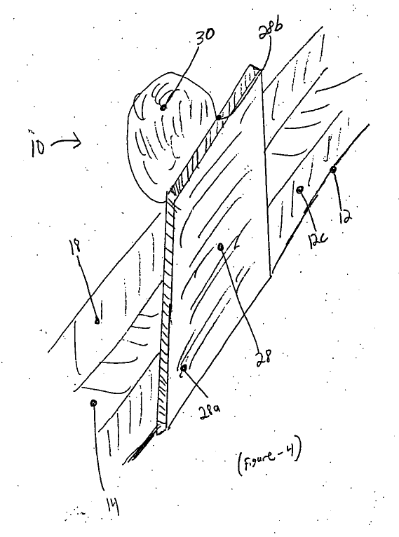

The clothesline apparatus of the present invention is shown in FIG. 1 and indicated generally by reference character 10. FIG. 1 shows a front perspective view of clothesline apparatus 10 in an open position. It contains horizontal member 12 having first end 12a, second end 12b, and exterior surface 12c. First arm 14 is pivotally connected to first end 12a of horizontal member 12 by first pivot joint 16a. Second arm 18 is pivotally connected to second end 12b of horizontal member 12 by second pivot joint 16b. The first and second arms (14, 18) rotate about the first and second pivot joints (16a, 16b) respectively so that arms (14, 18) are foldable into a closed position as shown in FIG. 2. A number of lines 20 made of cord, sash, bungee, or other appropriate material, connect between first arm 14 and second arm 18, and are threaded through holes spaced along first arm 14 and second arm 18. Clothesline apparatus 10 connects to trailer coupler 22 as shown in FIGS. 3 and 4. Trailer coupler 22 is attached to trailer 24.

FIG. 2 shows a front perspective view of clothesline apparatus 10 in a closed position. Pivot joints 16a and 16b each contain metal plates 26 that are welded and/or bolted to exterior surface 12c of horizontal member 12 at first end 12a and second end 12b. First arm 14 and second arm 18 fit between metal plates 26 at each end (12a, 12b) of horizontal member 12.

FIG. 3 shows a closeup top perspective view of ball mounting plate 28 with first end 28a and second end 28b. First end 28a of ball mounting plate 28 attaches to exterior surface 12c of horizontal member 12 of clothesline apparatus 10. In one embodiment of the invention, ball mounting plate 28 is welded and/or bolted to exterior surface 12c of horizontal member 12 of clothesline apparatus 10. Second end 28b of ball mounting plate 28 is connected to ball unit 30. Ball mounting plate 28 and ball unit 30 connect to trailer coupler 22 (FIG. 1), which secures the entire device to trailer 24.

FIG. 4 shows a closeup bottom perspective view of ball mounting plate 28 and ball unit 30 of closeline apparatus 10 of FIG. 1. In this embodiment of the invention, ball unit 30 is secured to ball mounting plate 28 by a washer, nut, and bolt, or any other equivalent means. Ball unit 30 is drilled to receive a bolt.

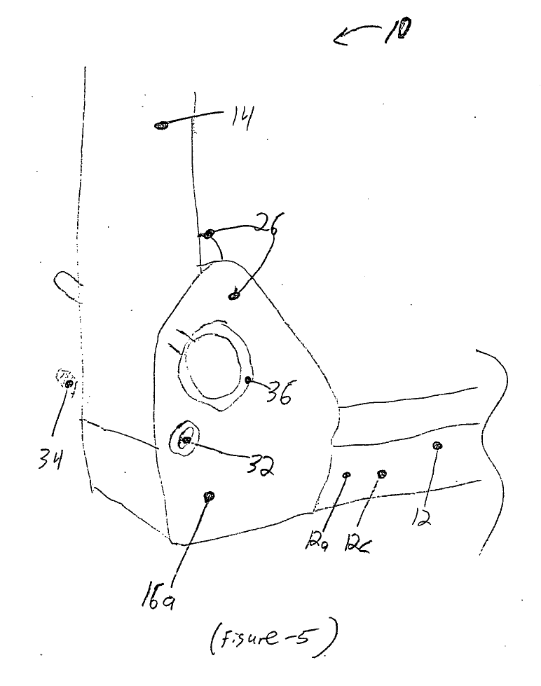

FIG. 5 shows a closeup front perspective view of first pivot joint 16a of clothesline apparatus 10 of FIG. 1. First pivot joint 16a consists of two metal plates 26 welded and/or bolted to exterior surface 12c of horizontal member 12, a pivot bolt 32 passing perpendicularly through metal plates 26 and first arm 14. First arm 14 rotates about pivot bolt 32. First pivot joint 16a is tightened via nylock nuts 34 and locking pin 36, or by some other equivalent securing mechanism.

Ball unit 30 (FIG. 3) fits inside trailer coupler 22 (FIG. 2), and ball mounting plate 28 is secured to trailer coupler 22 by a number of nuts and bolts or other equivalent fastening device. Since ball mounting plate 28 is attached to horizontal member 12, the entire clothesline apparatus 10 can be attached in the closed position (FIG. 2) to trailer coupler 22 (FIGS. 1 & 2) when clothesline apparatus 10 is not in use. Once attached to trailer coupler 22, which is attached to trailer 24, clothesline apparatus 10 can be easily opened.

Second arm 18 is lifted in an upward, clockwise direction, which rotates it about pivot bolt 32 of pivot joint 16b to the open position shown in FIG. 1. Pivot joint 16b is then tightened via nylock nuts 34 and locking pin 36. First arm 14 is then lifted in an upward, counterclockwise direction, which rotates it about pivot bolt 32 of pivot joint 16a to the open position shown in FIG. 1. Pivot joint 16a is then tightened via nylock nuts 34 and locking pin 36. Finally, lines 20 are threaded through holes in first arm 14 and second arm 18, and pulled taught to pick up their slack. Clothes or towels can then be hung on any of lines 20.

Clothesline apparatus 10 can be easily removed in one piece by simply reversing the process described previously. Pivot joints (16a, 16b) are loosened, and first arm 14 and second arm 18 are rotated back to the closed position of FIG. 2. Lines 20 can be removed or wrapped around clothesline apparatus 10 in the closed position. The nuts and bolts holding ball mounting plate 28 to trailer coupler 22 are removed, which removes clothesline apparatus 10 from trailer coupler 22 as ball unit 30 slides out of trailer coupler 22.

In one embodiment of this invention, first arm 14, second arm 18, ball mounting plate 28, and ball unit 30 are made from aluminum so as to keep the clothesline apparatus light and prevent rusting.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A clothesline apparatus mountable to a trailer coupler, comprising:
a ball mounting plate having a first end and a second end;
a ball unit attached to said first end of said ball mounting plate, said ball unit attachable to said trailer coupler;
a horizontal member attached to said second end of said ball mounting plate, said horizontal member having a first end and a second end;
a first arm pivotally connected to said first end of said horizontal member; and
a second arm pivotally connected to said second end of said horizontal member wherein when said first arm and said second arm are extended in an open position, a line is securable from said first arm to said second arm such that clothes may be hung from said clothesline.

2. The clothesline apparatus as set forth in claim 1, further comprising a plurality of lines connected from said first arm to said second arm, so that a substantially vertical clothesline may be formed.

3. The clothesline apparatus as set forth in claim 1, wherein said horizontal member, said first arm and said second arm are fabricated out of an aluminum material.

4. The clothesline apparatus as set forth in claim 1, further comprising first and second pivot joints so that said first and second arms are pivotally connected to said first and second ends of said horizontal member.

5. The clothesline apparatus as set forth in claim 1, wherein said horizontal member remains fixed relative to said ball mounting plate and to said trailer coupler.

6. The clothesline apparatus as set forth in claim 1, wherein said ball unit is removable from said trailer coupler.

7. The clothesline apparatus as set forth in claim 1, wherein when said first and second arms are in a closed position, said first arm rests on said horizontal member and said second arm rests on said first arm.

8. The clothesline apparatus as set forth in claim 7, wherein when said first arm is moved into an open position, said arm is moved in a counterclockwise direction from a substantially horizontal position to a substantially vertical position.

9. The clothesline apparatus as set forth in claim 8, wherein when said second arm is moved to an open position, said arm is moved in a clockwise direction from a substantially horizontal position to a substantially vertical position.
